(19) United States
(12) Patent Application Publication
(10) Pub. No.: US 2007/0070962 A1
(43) Pub. Date: Mar. 29, 2007

(54) Communication networks for establishing communication sessions between a registered internet protocol (IP) device and one or more subscribing IP devices and methods and computer program products for operating the same

(75) Inventors: Bjorn Kilburn, Atlanta, GA (US); Gregory A. Dunko, Cary, NC (US); Cameron E. Shearon, Raleigh, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/238,539

(22) Filed: Sep. 29, 2005

(51) Int. Cl. H04Q 7/24

(52) U.S. Cl. 370/338

(57) ABSTRACT

A communication network is operated by registering an Internet protocol (IP) device as a content provider. The registration of the IP device as a content provider is detected at least one subscriber IP device. A communication session is established between the IP device registered as a content provider and the at least one subscriber IP device. Content is provided from the IP device registered as the content provider to the at least one subscriber IP device.

### BACKGROUND OF THE INVENTION

The present invention relates to communication networks and methods of operating the same, and, more particularly, to Internet protocol (IP) multimedia subsystem (IMS) networks and methods of operating the same.

One evolution in the development of communication networks, such as mobile communication networks, has been the shift from circuit switching to packet switching in the core network. A circuit-switched approach is based on using a dedicated circuit between a caller and a recipient of a call. One drawback to this approach is that certain network resources associated with the circuit path may be unavailable to anyone else for the duration of the call. In contrast, packet-switching technology operates by splitting the communication traffic into information units called packets, which are transmitted over a common circuit before being organized and re-assembled at their destinations. The packets may carry voice or data information. This sharing of resources and the ability to use common network protocols may lead to a more cost-effective transmission system for network operators. Moreover, because more efficient routing techniques are generally used in packet-switched networks, information may be transmitted at higher speeds than may be possible in circuit-switched networks. The higher data speeds may support multiple services in a single session, such as voice, text, graphics, and/or video thereby supporting multi-media applications.

The Internet protocol (IP) multimedia subsystem (IMS) is a standard that has been developed to define the control and integration of multimedia services in a core, packet-switched network. In particular, the IMS architecture defines a set of logical functions that use a signaling protocol known as the session initiation protocol (SIP). SIP is used to establish communication sessions in an IP network. For example, a session may be a one-to-one voice call or a session may be more complex, such as one-to-many conference calls involving multimedia services. SIP may also be used to facilitate voice over IP (VoIP) services, in which voice is transported in IP data packets that are re-assembled and converted into an audio signal for the recipient. By using VoIP, network operators may use the same IP infrastructure to carry voice traffic that is used to carry data traffic. Thus, IMS may be summarized as a standardized way to connect IP devices and networks using SIP.

### SUMMARY OF THE INVENTION

In some embodiments of the present invention, a communication network is operated by registering an Internet protocol (IP) device as a content provider. The registration of the IP device as a content provider is detected at least one subscriber IP device. A communication session is established between the IP device registered as a content provider and the at least one subscriber IP device. Content is provided from the IP device registered as the content provider to the at least one subscriber IP device.

In other embodiments of the present invention, the content is provided by obtaining the content in real time at the IP device registered as a content provider. The obtained content is provided from the IP device registered as the content provider to the at least one subscriber IP device in real time.

In other embodiments of the present invention, the content is provided by obtaining the content prior to establishing the communication session. The obtained content is provided from the IP device registered as the content provider to the at least one subscriber IP device in real time.

In other embodiments of the present invention, the content is provided by receiving a content request from one of the at least one subscriber IP device. The requested content is provided from the IP device registered as the content provider to the one of the at least one subscriber IP device.

In still other embodiments of the present invention, the content is provided by providing video of an event combined with audio associated with the event. The audio may be generated by the event or may be generated by a source other than the event.

In still other embodiments of the present invention, the audio comprises a broadcast that has been captured for rebroadcast.

In still other embodiments of the present invention, registering the IP device as a content provider comprises associating a name, location, availability, presence, and/or content subject matter with the IP device in a server.

In still other embodiments of the present invention, detecting the registration of the first IP device comprises querying the server based on name, location, availability, presence, and/or content subject matter to obtain a query result. The registration of the first IP device as a content provider is detected at least one subscriber IP device based on the query result.

In still other embodiments of the present invention, registering the IP device as a content provider comprises sending an alert from the IP device registered as a content provider to the at least one subscriber IP device.

In still other embodiments of the present invention, detecting the registration of the first IP device comprises detecting the alert sent from the IP device registered as a content provider at the at least one subscriber IP device.

In still other embodiments of the present invention, registering the IP device as a content provider comprises registering the IP device as a content provider for a defined list of at least one subscriber. The at least one subscriber IP device is associated with the at least one subscriber comprising the defined list.

In still other embodiments of the present invention, registering the IP device as a content provider comprises registering the IP device as a content provider for any subscriber.

In still other embodiments of the present invention, the communication network comprises an IP multimedia subsystem network.

In still other embodiments of the present invention, establishing the communication session comprises establishing the communication session between the IP device registered as a content provider and the at least one subscriber IP device using session initiation protocol (SIP) signaling.

Although described above primarily with respect to method embodiments of the present invention, it will be understood that the present invention may be embodied as communication networks, and methods and computer program products for operating the same.

### BRIEF DESCRIPTION OF THE DRAWINGS

FIG. 1 is a block diagram that illustrates a communication network that may facilitate communication between a registered Internet protocol (IP) device and one or more subscriber devices in accordance with some embodiments of the present invention;

FIG. 2 is a block diagram of a mobile terminal/device in accordance with some embodiments of the present invention; and

FIG. 3 is a flowchart that illustrates operations of the communication network of FIG. 1 and mobile terminal/device of FIG. 2 in accordance with some embodiments of the present invention.

### DETAILED DESCRIPTION OF EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, mobile terminals, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal or device” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

As used herein, the term “IP terminal or device” refers to a terminal or device that may communicate using the session initiation protocol (SIP). Thus, a “mobile IP terminal” may be a device that includes both characteristics of a “mobile terminal” and an “IP terminal or device.” It will be understood that an IP terminal or device may also refer to devices that communicate using SIP via a media gateway, which translates communications, for example, between an IP network and another network, such as the public switched telephone network or a circuit switched wireless network.

As used herein, the term “packet” means a unit of information and/or a block of data that may be transmitted electronically as a whole or via segments from one device to another. Accordingly, as used herein, the term “packet” may encompass such terms of art as “frame” and/or “message,” which may also be used to refer to a unit of transmission.

Some embodiments of the present invention stem from a realization that an IP terminal or device may be used to provide content to one or more other IP terminals or devices using, for example, an Internet protocol (IP) multimedia subsystem (IMS) network. In particular, the SIP protocol may be used to establish peer-to-peer communication sessions between IP terminals/devices to allow an IP terminal/device to provide multi-media content to one or more other IP terminals/devices. Thus, according to some embodiments of the present invention, an IP terminal/device may be used to provide remote reporting of events. For example, one individual may record an event, such as a sporting event or other news event, in real-time and send the video and/or audio information to one or more individuals that wish to receive that content. The audio information may be, for example, audio generated by the event and captured for retransmission or may be supplemental audio, such as commentary or editorial content, provided by a broadcasting party.

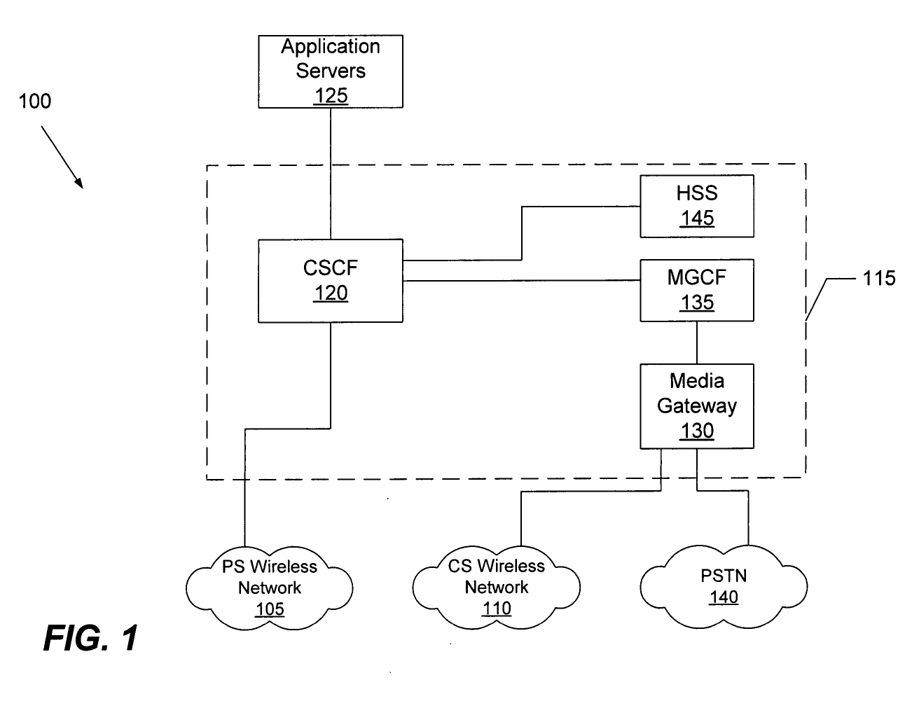

Referring to FIG. 1, a communication network 100, in accordance with some embodiments of the present invention, comprises wireless communication networks 105 and 110, which are coupled to an Internet protocol (IP) multimedia subsystem (IMS) network 115 as shown. The wireless network 105 may be a packet-switched network that serves one or more IP terminals/devices. The wireless network 110 may be a circuit-switched network that provides communication facilities for one or more mobile terminals. In accordance with various embodiments of the present invention, the IP terminal providing content to one or more other IP terminals or devices may be connected to either the packet-switched wireless network 105 or the circuit-switched wireless network 110. Likewise, an IP terminal that receives content from an IP terminal or device may be connected to either the packet-switched wireless network 105 or the circuit-switched wireless network 110.

The wireless network 105 connects to the IMS network 115 via the call session control function (CSCF) 120. The CSCF 120 is connected to one or more application servers 125 and enables the registration of IP terminals/devices and the routing of session initiation protocol (SIP) signaling messages between the application servers 125 and the IP terminals/devices. The CSCF 120 may provide similar functionality for the mobile terminals/devices connected serviced by the wireless network 110 via a media gateway 130 and media gateway control function (MGCF) 135. The MGCF 135 enables SIP signaling to inter-work with other types of signaling used by the media gateway 130. Thus, the combination of the MGCF 135 and the media gateway 130 may provide an interface between the SIP signaling used in the IMS network 115 and the signaling used in the wireless network 110 and/or the public switched telephone network (PSTN) 140.

The communication network 100 may further comprise a home subscriber server (HSS) database 145 that maintains a service profile and other information for each end-user and associated IP terminal/device that has registered with the IMS network 115. The profile and other information may include, but is not limited to, IP address information, roaming information, and/or telephony services information. Moreover, as will be described in more detail hereafter, the HSS may store information regarding whether an IP terminal/device has registered as a content provider for other, subscribing, IP terminals/devices and whether a subscribing IP terminal/device should be alerted when a particular content providing IP terminal/device has registered to indicate that it has content available for transmission.

The various elements of the communication network 100 may be connected by a global network, such as the Internet or other publicly accessible network. Various elements of the network may be interconnected by a wide area network, a local area network, an Intranet, and/or other private network, which may not accessible by the general public. Thus, the communication network 100 may represent a combination of public and private networks or a virtual private network (VPN). Although FIG. 1 illustrates an exemplary communication network, it will be understood that the present invention is not limited to such configurations, but is intended to encompass any configuration capable of carrying out the operations described herein.

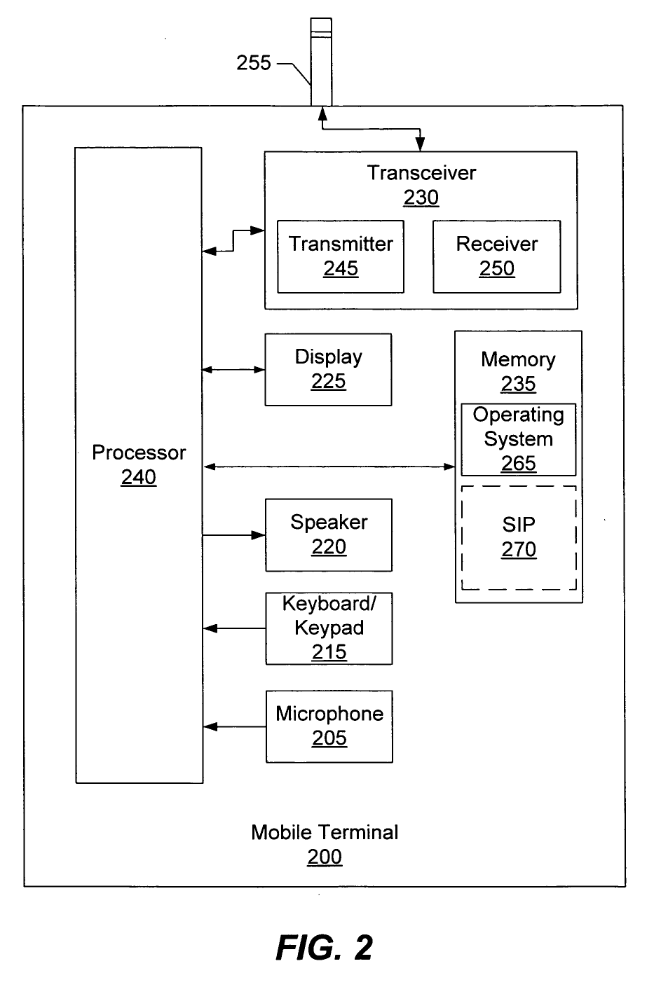

Referring to FIG. 2, an exemplary mobile IP terminal 200 that may be served, for example, by wireless communication networks 105 and 110, in accordance with some embodiments of the present invention, comprises at least one microphone 205, a keyboard/keypad 215, a speaker 220, a display 225, a transceiver 230, and a memory 235 that communicate with a processor 240. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, general packet radio services (GPRS) information. The foregoing components of the mobile IP terminal 200 may be included in many conventional mobile terminals and their functionality is generally known to those skilled in the art.

The processor 240 communicates with the memory 235 via an address/data bus. The processor 240 may be, for example, a commercially available or custom microprocessor. The memory 235 is representative of the one or more memory devices containing the software and data used to facilitate communication via the communication network 100 of FIG. 1, in accordance with embodiments of the present invention. The memory 235 may include, but is not limited to, the following types of devices: cache, ROM, PROM, EPROM, EEPROM, flash, SRAM, and DRAM.

As shown in FIG. 2, the memory 235 may contain up to two or more categories of software and/or data: the operating system 265 and the SIP module 270. The operating system 265 generally controls the operation of the mobile IP terminal. In particular, the operating system 265 may manage the mobile terminal's software and/or hardware resources and may coordinate execution of programs by the processor 240. The SIP module 270 may be configured to implement the session initiation protocol so as to allow the mobile terminal to establish sessions with other IP terminals or devices. In some embodiments, the mobile terminal 200 may not include a SIP module if, for example, the mobile terminal 200 is served by the circuit-switched network 110 of FIG. 1 or the mobile terminal accesses the IMS network 115 via the MGCB 135 and the media gateway 130 of FIG. 1.

Although FIG. 2 illustrates an exemplary software and hardware architecture of a mobile IP terminal/device in accordance with some embodiments of the present invention, it will be understood that the present invention is not limited to such a configuration but is intended to encompass any configuration capable of carrying out the operations described herein.

Computer program code for carrying out operations of the communication network 100 and/or mobile terminals 200 discussed above with respect to FIGS. 1 and 2 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of communication networks, methods, and computer program products in accordance with some embodiments of the invention. These flowchart and/or block diagrams further illustrate exemplary operations of the communication network and mobile terminal/device architectures of FIGS. 1 and 2. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

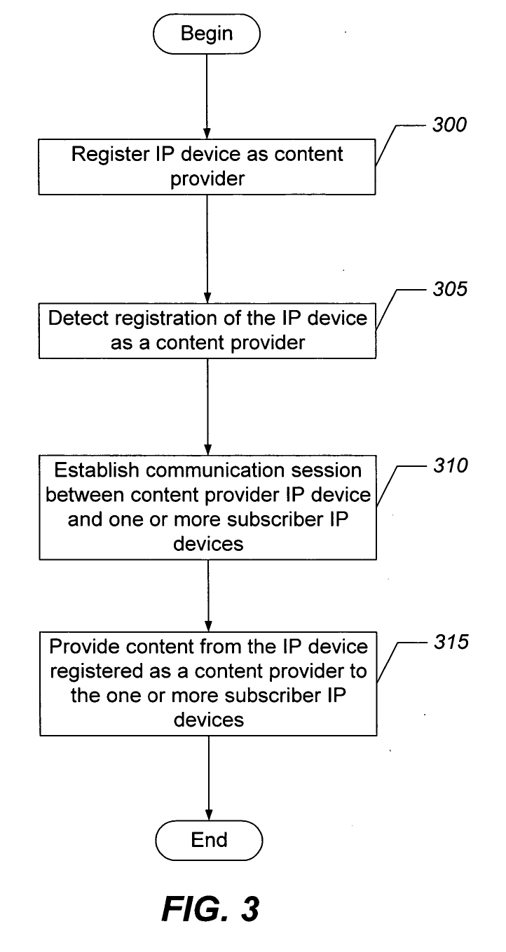

Referring to FIG. 3, operations for establishing a communication session on the communication network 100 of FIG. 1 to provide content from one IP terminal/device to one or more other IP devices, in accordance with some embodiments of the present invention, begin with an IP device registering as a content provider (block 300). In accordance with some embodiments of the present invention, an IP terminal/device may register with the IMS network 115 of FIG. 1 and have registration information stored in the HSS 145. This registration information may include, but is not limited to, a name, location, availability, presence, and/or content subject matter. This information may allow subscribers to evaluate whether they want to receive content from a particular content provider. In other embodiments, as part of the registration process, an IP terminal/device may send out alert messages to one or more subscribers notifying the subscribers that content is now available from that IP terminal/device. Depending on a likely target audience for the particular content being provided, the registration of an IP terminal/device as a content provider with the IMR network 115 may involve qualifying the registration as being applicable for only a defined list of one or more subscribers. Alternatively, the registration may be unqualified indicating that any subscriber that can communicate with the IP terminal/device that has registered as a content provider may receive content therefrom.

Returning to FIG. 3, operations continue with one or more subscriber IP terminals/devices detecting the registration of the IP terminal/device as a content provider (block 305). In accordance with various embodiments of the present invention, such detection may be accomplished by a subscriber IP terminal/device querying the HSS 145 based on the registration information discussed above, such as name, location, availability, presence, and/or content subject matter. In other embodiments, a subscriber IP terminal/device may detect an alert message sent from the IP terminal/device that has registered as a content provider indicating that content is available for consumption.

Once one or more subscriber IP terminals/devices detect that another IP terminal/device has registered as a content provider, a communication session may be established between the IP terminal/device that has registered as a content provider and the one or more subscriber IP terminals/devices that has detected the registration (block 310). In accordance with some embodiments of the present invention, the communication session may be a peer-to-peer communication session SIP between the IP terminal/device that has registered as a content provider and the one or more subscriber IP terminals/devices that is established using SIP.

Once the communication session(s) is/are established, then content can be provided from the IP terminal/device registered as a content provider to the one or more subscriber IP terminals/devices (block 315). In accordance with various embodiments of the present invention, the content can be obtained in real-time at the IP terminal/device that has registered as a content provider and provided the one or more subscriber IP terminals/devices. Examples of such real-time content delivery include video from live sporting events and news events, such as fires, accidents, riots, and the like. As used herein a real-time operation is one in which the combined reaction and operation time of a task is shorter than a maximum delay that is allowed in view of the circumstances surrounding the operation. For example, when delivering content related to sporting events and/or news events, if the recipient were able to receive the content in a manner that was essentially considered to be a “live” broadcast, then the content would be considered to be provided in real-time even if there is a short delay between the live event and the recipient receiving the content. The content may also be obtained and saved either locally at the IP terminal/device that has registered as a content provider or at the HSS 145. This saved content may then be provided to the subscriber IP terminals/devices at a later time. In other embodiments of the present invention, content may be provided as a combination of both real-time content and previously saved content. For example, a video of an event may be saved and then provided later to one or more subscribers accompanied with a real-time commentary or analysis.

Advantageously, an IMS network 115 may allow an IP terminal/device to provide multi-media content to one or more other IP terminals/devices. Accordingly, the IP terminal/device that has registered as a content provider may provide video of an event combined with audio associated with the event to one or more subscriber IP terminals/devices. For example, a person may act as a content provider for a live sporting event and combine the video of the event along with play-by-play audio commentary to one or more subscriber IP terminals/devices. The audio commentary may even be a frequency modulated (FM)/amplitude modulated (AM) broadcast that is captured and optionally processed (e.g., digitally sampled/encoded) for retransmission, a local digital audio file, a captured satellite transmission that is processed, for example, in a manner similar to the FM/AM broadcast, or other audio file or broadcast that may be captured for retransmission. The audio commentary may then be paired with the live video feed obtained by the IP terminal/device that has registered as a content provider and provided to the one or more subscriber IP terminals/devices.

According to some embodiments of the present invention, a subscriber may tailor the content received according to individual preferences. For example, a subscriber IP terminal/device may communicate a content request to the IP terminal/device that has registered as a content provider. The content request may be, for example, a request to move the camera recording a scene to a different angle to obtain a different perspective on the scene, to focus on a particular aspect of the scene or to move to a new location entirely. The content request may also involve a request for additional audio or text information. The operator of the IP terminal/device that has registered as a content provider may then provide the requested content to the subscriber(s) to provide better service. Thus, embodiments of the present invention may be used to provide an interactive reporting service where content can be tailored to the particular preferences/needs of the subscribers.

The flowchart of FIG. 3 illustrates the architecture, functionality, and operations of embodiments of the communication network 100 and the mobile terminal 200 hardware and/or software. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Thus, according to some embodiments of the present invention, IP terminals/devices may be used in an IMS network, for example, to communicate peer-to-peer multi-media content between a content provider and one or more subscribers. The IP terminals/devices are not limited to a particular terminal/device type and may be, for example, mobile IP terminals/devices or stationary terminals/devices.

In the drawings and specification, there have been disclosed exemplary embodiments of the invention. Although specific terms are used, they are used in a generic and descriptive sense only and not for purposes of limitation, the scope of the invention being defined by the following claims.

That which is claimed:

1. A method of operating a communication network, comprising:
registering an Internet protocol (IP) device as a content provider;
detecting the registration of the IP device as a content provider at least one subscriber IP device;
establishing a communication session between the IP device registered as a content provider and the at least one subscriber IP device; and
providing content from the IP device registered as the content provider to the at least one subscriber IP device.

2. The method of claim 1, wherein providing the content comprises:
obtaining the content in real time at the IP device registered as a content provider; and
providing the obtained content from the IP device registered as the content provider to the at least one subscriber IP device in real time.

3. The method of claim 1, wherein providing the content comprises:
obtaining the content prior to establishing the communication session;
providing the obtained content from the IP device registered as the content provider to the at least one subscriber IP device in real time.

4. The method of claim 1, wherein providing the content comprises:
receiving a content request from one of the at least one subscriber IP device; and
providing the requested content from the IP device registered as the content provider to the one of the at least one subscriber IP device.

5. The method of claim 1, wherein providing the content comprises:
providing video of an event combined with audio associated with the event.

6. The method of claim 5, wherein the audio is generated by the event.

7. The method of claim 5, wherein the audio is generated by a source other than the event.

8. The method of claim 5, wherein the audio comprises a broadcast that has been captured for rebroadcast.

9. The method of claim 1, wherein registering the IP device as a content provider comprises:
associating a name, location, availability, presence, and/or content subject matter with the IP device in a server.

10. The method of claim 9, wherein detecting the registration of the first IP device comprises:
querying the server based on name, location, availability, presence, and/or content subject matter to obtain a query result; and
detecting the registration of the first IP device as a content provider at least one subscriber IP device based on the query result.

11. The method of claim 1, wherein registering the IP device as a content provider comprises:
sending an alert from the IP device registered as a content provider to the at least one subscriber IP device.

12. The method of claim 11, wherein detecting the registration of the first IP device comprises:
detecting the alert sent from the IP device registered as a content provider at the at least one subscriber IP device.

13. The method of claim 1, wherein registering the IP device as a content provider comprises:
registering the IP device as a content provider for a defined list of at least one subscriber; and
wherein the at least one subscriber IP device is associated with the at least one subscriber comprising the defined list.

14. The method of claim 1, wherein registering the IP device as a content provider comprises:
registering the IP device as a content provider for any subscriber.

15. The method of claim 1, wherein the communication network comprises an IP multimedia subsystem network.

16. The method of claim 15, wherein establishing the communication session comprises:
establishing the communication session between the IP device registered as a content provider and the at least one subscriber IP device using session initiation protocol (SIP) signaling.

17. A communication network, comprising:
an Internet protocol (IP) network that comprises a call session control function and a database;
an IP device that is configured to register as a content provider with the database via the call session control function; and
at least one subscriber IP device that is configured to detect registration and to receive content from the IP device that is registered as a content provider via the IP network.

18. The communication network of claim 17, wherein the database is configured to associate a name, location, availability, presence, and/or content subject matter with the IP device.

19. The communication network of claim 18, wherein the at least one subscriber IP device is configured to query the database based on the name, location, availability, presence, and/or content subject matter to obtain a query result and to detect registration of the IP device that is registered as a content provider based on the query result.

20. The communication network of claim 17, wherein the IP device is configured to send an alert to the at least one subscriber IP device to notify the at least one subscriber IP device that the IP device has registered as a content provider.

21. The communication network of claim 17, wherein the IP device is configured to receive a content request sent from the at least one subscriber IP device and to send the requested content to the at least one subscriber IP device.

22. The communication network of claim 17, wherein the IP network comprises an IP multimedia subsystem network.

23. A computer program product for operating a communication network comprising:
a computer readable storage medium having computer readable program code embodied therein, the computer readable program code comprising:
computer readable program code configured to register an Internet protocol (IP) device as a content provider;
computer readable program code configured to detect the registration of the IP device as a content provider at least one subscriber IP device;
computer readable program code configured to establish a communication session between the IP device registered as a content provider and the at least one subscriber IP device; and
computer readable program code configured to provide content from the IP device registered as the content provider to the at least one subscriber IP device.

24. The computer program product of claim 23, wherein the computer readable program code configured to provide the content comprises:
computer readable program code configured to receive a content request from one of the at least one subscriber IP device; and
computer readable program code configured to provide the requested content from the IP device registered as the content provider to the one of the at least one subscriber IP device.

25. The computer program product of claim 23, wherein the computer readable program code configured to register the IP device as a content provider comprises:
computer readable program code configured to associate a name, location, availability, presence, and/or content subject matter with the IP device in a server.

26. The computer program product of claim 25, wherein the computer readable program code configured to detect the registration of the first IP device comprises:
computer readable program code configured to query the server based on name, location, availability, presence, and/or content subject matter to obtain a query result; and
computer readable program code configured to detect the registration of the first IP device as a content provider at least one subscriber IP device based on the query result.

27. The computer program product of claim 23, wherein the computer readable program code configured to register the IP device as a content provider comprises:
computer readable program code configured to send an alert from the IP device registered as a content provider to the at least one subscriber IP device.

28. The computer program product of claim 27, wherein the computer readable program code configured to detect the registration of the first IP device comprises:
computer readable program code configured to detect the alert sent from the IP device registered as a content provider at the at least one subscriber IP device.

29. The computer program product of claim 23, wherein the communication network comprises an IP multimedia subsystem network.
